(19) United States
(12) Patent Application Publication
(10) Pub. No.: US 2008/0051185 A1
(43) Pub. Date: Feb. 28, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/790,192

(22) Filed: Apr. 24, 2007

Related U.S. Application Data
(60) Provisional application No. 60/840,021, filed on Aug. 25, 2006.

(51) Int. Cl. A63F 13/00

(52) U.S. Cl. 463/20

(57) ABSTRACT

A slot machine according to the present invention comprises: a display to which a plurality of symbols are to be arranged and which is also capable of displaying an amount of payout based on the symbols; and a controller, the controller rearranging a plurality of symbols sequentially over a plurality of times within the display, calculating a maximum amount of payout which can be paid out in rearrangement of symbols not yet rearranged, based on the rearranged symbols, the maximum amount of payout calculated during one of the sequential rearrangement processes, and displaying the calculated maximum amount of payout to the display.

### CROSS-REFERENCE TO RELATED APPLICATIONS

This application claims priority of U.S. Provisional Application No. 60/840,021 filed on Aug. 25, 2006. The contents of this application are incorporated herein by reference in their entirety.

### BACKGROUND OF THE INVENTION

1. Field of the Invention

The present invention relates to a slot machine and a playing method thereof.

2. Discussion of the Background

In conventional slot machines, if a player inserts game media such as medals, coins or bills into an insertion slot of the slot machine and pushes a spin button, then a plurality of symbols are displayed in a scrolling manner on a display provided on the front surface of a casing and, thereafter, the respective symbols are automatically stopped, as disclosed in U.S. Pat. Nos. 6,960,133 and 6,012,983, and 6,093,102. In this case, when the respective symbols start to be displayed in a scrolling manner by the input through the spin button, symbols are selected using random numbers, and if the combination of the selected symbols is a predetermined winning combination, this causes transition from a basic game to a bonus game (for example, a mystery bonus, a second game and the like) and, then, the bonus game is executed. Further, such slot machines are configured to conduct a payout depending on the winning state occurring along with progression of games.

Further, among conventional slot machines, there are some slot machines which conduct two types of payouts which are payouts determined according to the combinations of symbols rearranged along winning lines and payouts determined according to the number of displayed scatter symbols, as disclosed in U.S. Pat. No. 6,604,999 and US 2002-0065124-A1.

It is an object of the present invention to notify a game player of a change in possibility for establishment of a winning combination with time in a process where symbols are rearranged, and to provide a new entertainment factor.

The contents of U.S. Pat. Nos. 6,960,133, 6,012,983, 6,093,102 and 6,604,999 and US 2002-0065124-A1 are incorporated herein by reference in their entirety.

### SUMMARY OF THE INVENTION

The present invention provides a slot machine having the following configuration.

Namely, the aforementioned slot machine comprises a display to which a plurality of symbols are to be arranged and which is also capable of displaying an amount of payout based on the symbols and a controller. The controller rearranges a plurality of symbols sequentially over a plurality of times within the display, and calculates a maximum amount of payout which can be paid out in rearrangement of symbols not yet rearranged, based on the rearranged symbols, the maximum amount of payout calculated during one of the sequential rearrangement processes. Sequentially, the controller displays the calculated maximum amount of payout to the display.

Further, the present invention is capable of adopting the following configuration in addition to the above configuration.

The above-mentioned controller further comprises changing an effect within the display when the maximum amount of payout which can be paid out in rearrangement of symbols not yet rearranged is maintained as a result of the rearrangement of symbols in the rearrangement process.

Further, the present invention is capable of adopting the following configuration in addition to the above configuration.

The controller further comprises finishing the current round of game when the amount of payout which can be paid out in rearrangement of symbols not yet rearranged becomes 0 as a result of the rearrangement of symbols in the rearrangement process.

### BRIEF DESCRIPTION OF DRAWINGS

FIG. 1 is an exemplary image displayed to a display in a slot machine according to one embodiment of the present invention.

FIG. 2 is another exemplary image displayed to a display in a slot machine according to one embodiment of the present invention.

FIG. 3 is an exemplary image displayed to a display in a slot machine according to one embodiment of the present invention.

FIG. 4 is an exemplary image displayed to a display in a slot machine according to one embodiment of the present invention.

FIG. 5 is a perspective view schematically showing a slot machine according to one embodiment of the present invention.

FIG. 6A is a view showing one example of symbol arrays.

FIG. 6B is a view showing the possibility for establishment of each winning combination and the number of payouts.

FIG. 7 is a block diagram showing the internal configuration of the slot machine shown in FIG. 5.

FIG. 8 is a flowchart showing a subroutine of a slot game execution processing.

FIG. 9 is a flowchart showing a subroutine of a symbol rearrangement processing.

FIG. 10 is a perspective view schematically showing a slot machine according to another embodiment of the present invention.

FIG. 11 is a perspective view schematically showing a slot machine according to another embodiment of the present invention.

### DESCRIPTION OF THE EMBODIMENTS

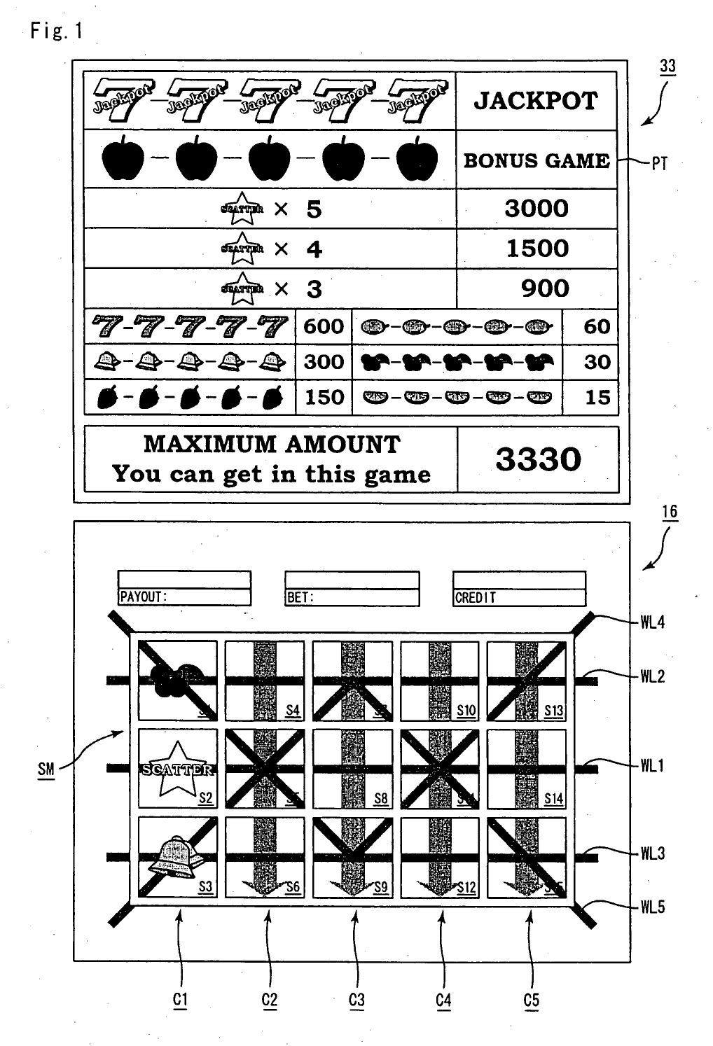

Each of FIGS. 1 to 4 is an exemplary image displayed to a display (an upper image display panel 33 and a lower image display panel 16) in a slot machine 10 according to one embodiment of the present invention. It is to be noted that, while the slot machine 10 is a standalone type slot machine which is not connected to a network, the present invention is applicable to a slot machine connected to the network.

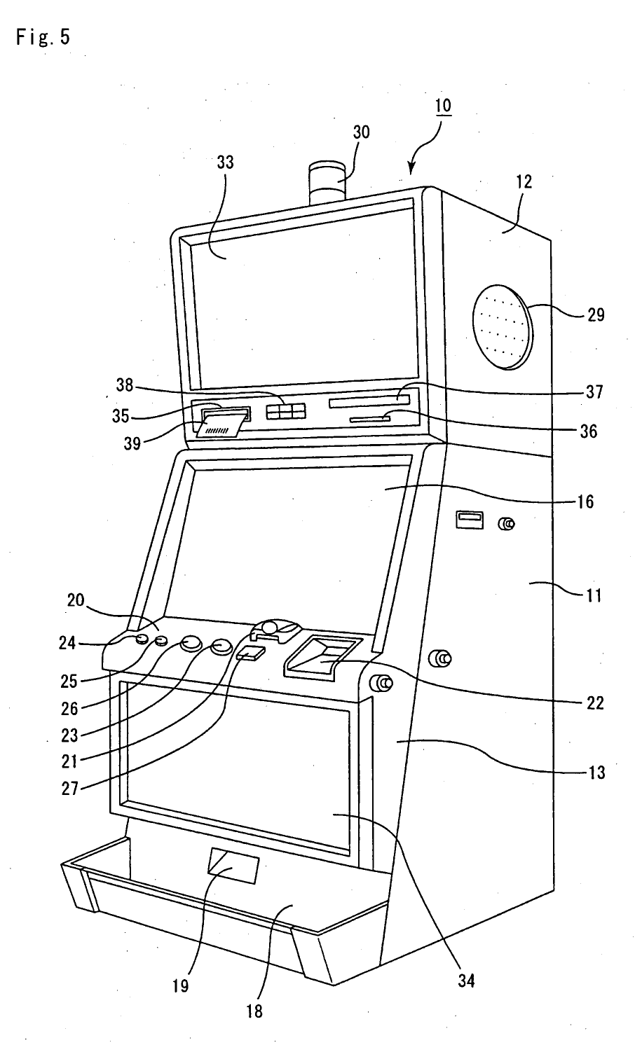

A symbol matrix SM shown in FIG. 1 is displayed to the lower image display panel 16 in the slot machine 10 of the present invention (see FIG. 5). The symbol matrix SM has five columns and three rows, consisting of a total of 15 symbols S1 to S15. In the figure, the five columns are shown as C1 to C5. In the symbol matrix SM, five winning lines WL1 to WL5 are set across all the columns C1 to C5. In the present embodiment, the number of winning lines to be made effective is different depending upon the number of BETs.

Each symbol S (S1 to S15) is scrolled in the direction of the arrows shown in the figure along the column C (C1 to C5). For example, on the column C1, the symbols S1 to S3 are scrolled such that the symbol S1 shifts to the symbol S2, and the symbol S2 shifts to the symbol S3. Subsequently, each of the symbols S stops scrolling and is rearranged. A payout value is determined according to the symbols S rearranged in the symbol matrix SM. FIG. 1 shows how the symbols S1, S2 and S3 on the column C1 are rearranged to “CHERRY”, “SCATTER” and “BELL”, respectively, while the symbols S4 to S15 on the columns C2 to C5 are scroll-displayed. The heavy-line arrows shown in the figure represent scroll-displays of the symbols S.

A payout table PT shown in FIG. 1 is displayed to the upper image display panel 33 (see FIG. 5) in the slot machine 10 of the present invention. Winning combinations “JACKPOT7”, “APPLE”, “SCATTER×5”, “SCATTER×4” and “SCATTER×3” are displayed in this order from the top row of the payout table PT. Further, the bottom three rows of the payout table PT are divided to the right side and left side. On the left side, winning combinations “BLUE7”, “BELL” and “STRAWBERRY” are displayed in this order from the top. On the right side, winning combinations “PLUM”, “CHERRY” and “ORANGE” are displayed in this order from the top. Further, at the right of the respective winning combinations displayed therein, the payout values for the respective corresponding winning combinations are displayed.

In the example illustrated in FIG. 1, three types of winning combinations “CHERRY”, “SCATTER×5” and “BELL”, out of the aforementioned eleven types of winning combinations, have a possibility of being established at the same time. Accordingly, in the example illustrated in FIG. 1, the maximum expected amount of payout is 30+3000+300=3330. The maximum expected amount of payout is displayed under the payout table PT, to the upper image display panel 33.

In the slot machine 10, symbols S are sequentially rearranged along the respective columns C, starting from the leftmost column C1. During the process, the maximum expected amount of payout displayed to the upper image display panel 33 is changed. Such processes will be described hereinafter.

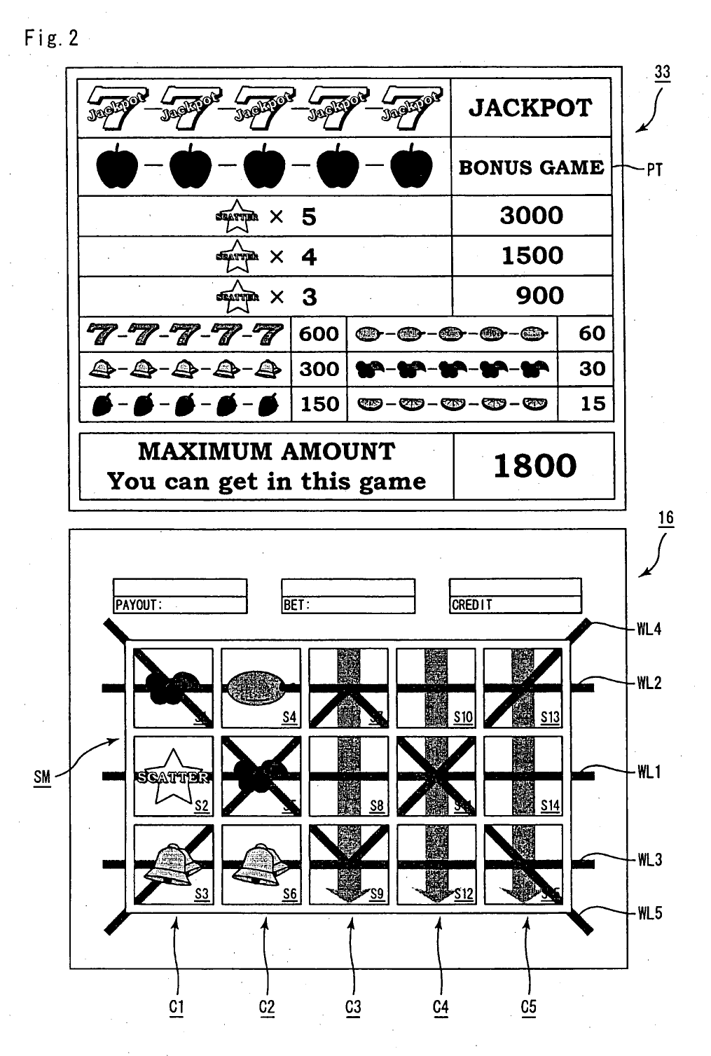

FIG. 2 illustrates an exemplary image displayed when symbols S4 to S6 along the column C2 have been rearranged from the state illustrated in FIG. 1.

The symbol S4 “PLUM”, the symbol S5 “CHERRY” and the symbol S6 “BELL” have been rearranged on the column C2. In this case, two types of winning combinations “BELL” and “SCATTER×4” have a possibility of being established at the same time. Although the winning combination constituted by “CHERRY” also has a possibility of being established, it cannot be established at the same time as the winning combination constituted by “BELL” and also has a payout value lower than that of the winning combination constituted by “BELL”. Therefore, the winning combination constituted by “CHERRY” is not subject to the winning combination with the possibility of being established at the same time.

Accordingly, in the example illustrated in FIG. 2, the maximum expected amount of payout is 1500+300=1800. The maximum expected amount of payout is displayed under the payout table PT, to the upper image display panel 33.

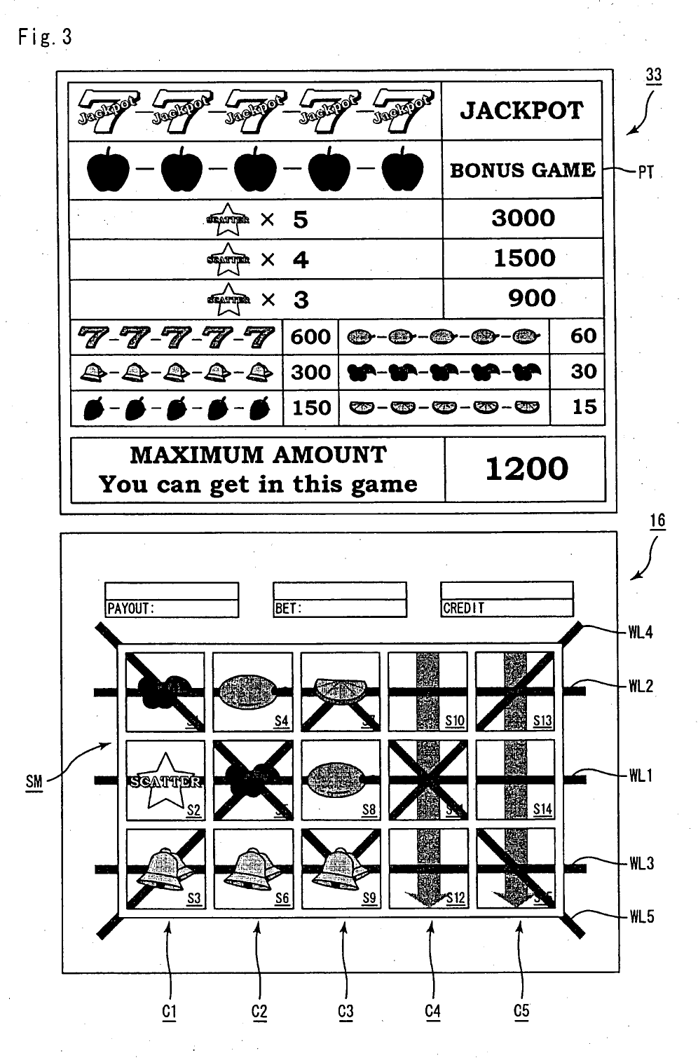

FIG. 3 illustrates an exemplary image displayed when symbols S7 to S10 along the column C3 have been rearranged from the state illustrated in FIG. 2.

The symbol S7 “ORANGE”, the symbol S8 “PLUM” and the symbol S9 “BELL” have been rearranged on the column C3. In this case, two types of winning combinations “BELL” and “SCATTER×3” have a possibility of being established at the same time.

Accordingly, in the example illustrated in FIG. 3, the maximum expected amount of payout is 900+300=1200. The maximum expected amount of payout is displayed under the payout table PT, to the upper image display panel 33.

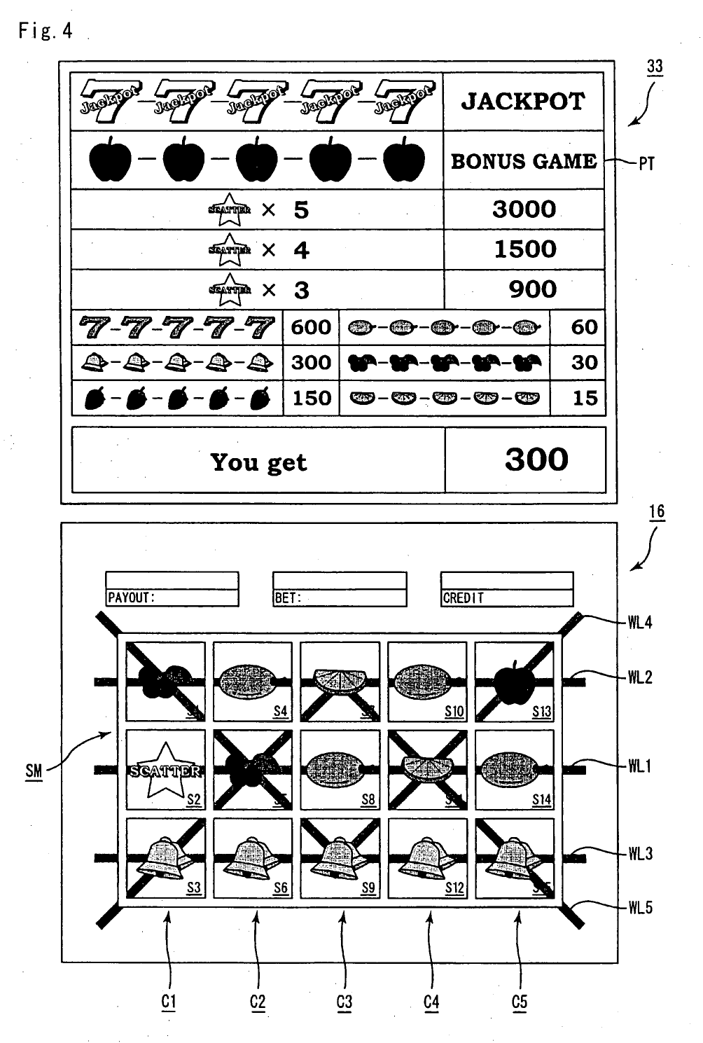

FIG. 4 illustrates an exemplary image displayed when symbols S10 to S15 along the columns C4 and C5 have been rearranged from the state illustrated in FIG. 3.

The symbol S10 “PLUM”, the symbol S11 “ORANGE” and the symbol S12 “BELL” have been rearranged on the column C4. The symbol S13 “APPLE”, the symbol S14 “PLUM” and the symbol S15 “BELL” have been rearranged on the column C5. This has resulted in establishment of the winning combination constituted by “BELL”.

The payout value “300” based on the established winning combination constituted by “BELL” is displayed under the payout table PT, to the upper image display panel 33.

While the case of displaying the symbol matrix SM consisting of a total of 15 symbols (five columns×three rows) to the lower image display panel 16 in the slot machine 10 is described in the present embodiment, the numbers of columns and rows which constitute the symbol matrix are not particularly limited in the present invention. Further, in the present invention, it is not necessarily required to configure the symbol matrix by symbols. The arrangement position as well as the figuration of the symbols can be changed as appropriate.

In the present embodiment, there has been described a case where a plurality of symbols are arranged to the lower image display panel 16, and the payout value is displayed to the upper image display panel 33, namely the two image display panels 16 and 33 correspond to the display included in the slot machine according to the present invention. However, the present invention is not limited to the case. The arrangement of a plurality of symbols and the display of the payout value can be performed on a single image display panel. In this case, the aforementioned image display panel constitutes the display included in the slot machine according to the present invention. Also, it is possible to arrange a plurality of symbols using mechanical reels while displaying the payout value to an image display panel. In this case, the aforementioned mechanical reels and the aforementioned image display panel constitute the display included in the slot machine according to the present invention.

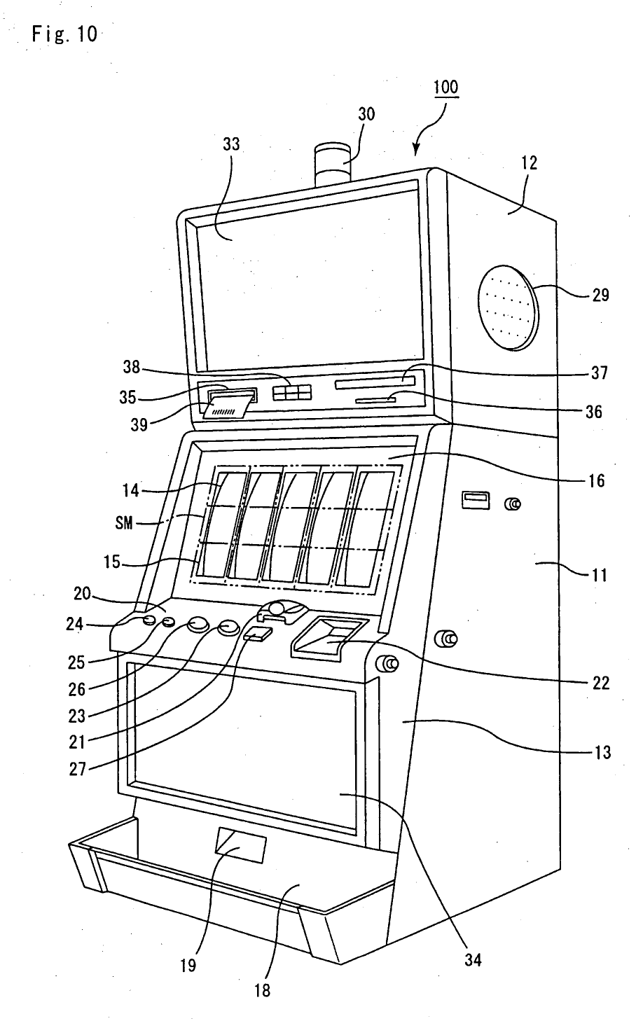

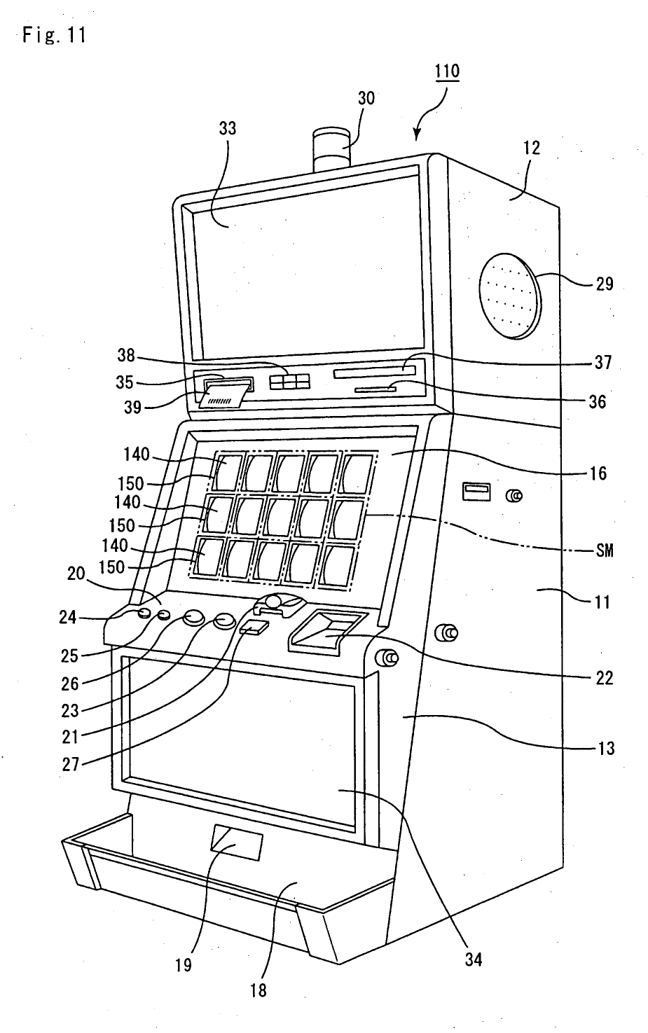

While the case of displaying symbols to the lower image display panel 16 is described in the present embodiment, it is not necessarily required in the present invention to display symbols as an image. For example, it is possible to adopt the present invention to a slot machine comprising reels (see FIGS. 10 and 11).

In the present embodiment, there was described the case where a total of 15 symbols (five columns×three rows) are rearranged per column over five times. However, the number of times of rearrangement (hereinafter also referred to as the number of rearrangement) and the number of symbols to be rearranged in each one rearrangement are not particularly limited so long as a plurality of symbols are rearranged over a plurality of times. Further, the number of rearrangement and the number of symbols to be rearranged in each one rearrangement may be changed in each game.

In the present embodiment, there will be described a case where, when the maximum amount of payout to be paid out in rearrangement of symbols not yet rearranged (hereinafter, referred to as a maximum expected amount of payout) is maintained during one of the sequential rearrangement processes, an effect for enlarging the display mode of the maximum expected amount of payout is executed. However, in the present invention, the way of changing an effect is not limited to the case. Also, winning combinations with the possibility of being established can be displayed along with the display of the maximum expected amount of payout. Also, the payout values which have a possibility of constituting a displayed maximum expected amount of payout can be displayed.

FIG. 5 is a perspective view schematically showing a slot machine according to one embodiment of the present invention.

The slot machine 10 comprises a cabinet 11, a top box 12 set to the upper side of the cabinet 11, and a main door 13 provided at the front face of the cabinet 11. The lower image display panel 16 is provided at the front of the main door 13. The lower image display panel 16 comprises a liquid crystal panel, to which the symbol matrix SM (see FIGS. 1 to 4) consisting of a total of 15 symbols (five columns×three rows) is displayed. A number-of-credits display section 31 and a number-of-payouts display section 32 (not shown) are set on the lower image display panel 16. The number of credited coins is displayed by means of an image to the number-of-credits display section 31. The number of coins to be paid out as a payout is displayed by means of an image at the number-of-payouts display section 32.

Further, although not shown, a touch panel 69 is provided at the front face of the lower image display panel 16, and the player can operate the touch panel 69 to input a variety of commands.

Below the lower image display panel 16, there are provided a control panel 20 comprised of a plurality of buttons 23 to 27 with each of which a command according to the game progress is inputted by the player, a coin receiving slot 21 through which a coin is accepted into the cabinet 11, and a bill validator 22.

The control panel 20 is provided with a start button 23, a change button 24, a cash-out button 25, a 1-BET button 26, and a maximum BET button 27. The start button 23 is a button for inputting a command to start a game. The change button 24 is used for requesting of an attendant at a recreation facility for exchange. The cash-out button 25 is a button for inputting a command to pay out credited coins to a coin tray 18.

The 1-BET button 26 is a button for inputting a command to bet one coin on a game out of credited coins. The maximum BET button 27 is a button for inputting a command to bet the maximum number of coins that can be bet on one game (three coins in the present embodiment) on a game out of credited coins.

The bill validator 22 not only discriminates a true note from a false note, but also accepts the true note into the cabinet 11. It is to be noted that bill validator 22 may be configured so as to be capable of reading a later-described ticket 39 with a bar code. At the lower front of the main door 13, namely below the control panel 20, belly glass 34 on which a character or the like of the slot machine 10 is drawn is provided.

In the front surface of the top box 12, the upper image display panel 33 is provided. The upper image display panel 33 includes a liquid crystal display panel for displaying a plurality of types of winning combinations and for displaying a maximum expected amount of payout (see FIGS. 1 to 4).

Further, the top box 12 is provided with a speaker 29. To the lower side of the upper image display panel 33, a ticket printer 35, a card reader 36, a data display 37 and a key pad 38 are provided. The ticket printer 35 prints on a tickets a bar code as coded data of the number of credits, a date, an identification number of the slot machine 10, and the like, and outputs the ticket as a ticket 39 with a bar code. It is possible for the player to make another slot machine to read the ticket 39 with a bar code and play a game on the slot machine, or exchange the ticket 39 with a bar code for notes or the like at a predetermined place in a game facility (e.g. a cashier in a casino).

The card reader 36 serves to read data from a smart card and write data into the smart card. The smart card is owned by the player, and for example, data for identifying the player, data of history of games played by the player are stored into the smart card. Data corresponding to coins, notes, or credit may be stored into the smart card. Further, a magnetic stripe card may be adopted in place of the smart card. The data display 37 is comprised of a fluorescent display and the like, and serves to display, for example, data read by the card reader 36, and data inputted by the player through the key pad 38. The key pad 38 is used to input a command or data concerning issuance of a ticket and the like.

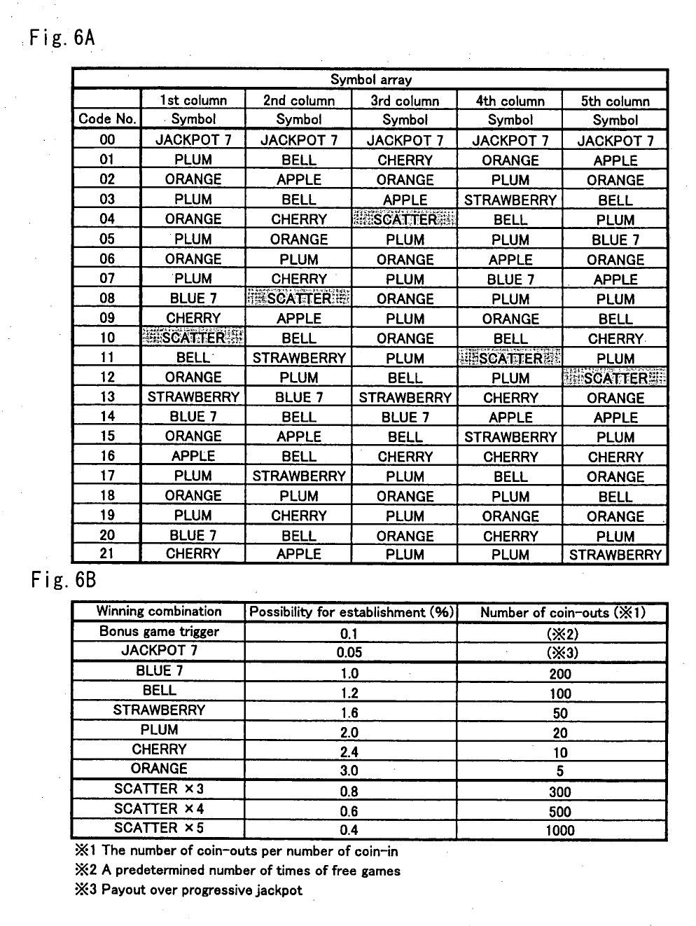

FIG. 6A is a graph showing a symbol array according to one embodiment of the slot machine of the present invention. On each of columns C1 to C5, 22 symbols are arranged. There exist nine types of symbols “APPLE”, “JACKPOT7”, “BLUE7”, “BELL”, “STRAWBERRY”, “PLUM”, “CHERRY”, “ORANGE” and “SCATTER”. In the present embodiment, symbols are scrolled based upon the symbol array. For example, in a case where the symbols S1 to S3 of the first column C1 (see FIG. 1) are “JACKPOT7”, “PLUM” and “ORANGE” (code Nos. 1, 2 and 3), when the symbols S1 to S3 are scrolled once and displayed, the symbols S1 to S3 are respectively “CHERRY”, “JACKPOT7” and “PLUM” (code Nos. 21, 1 and 2).

When five of the same type of symbols, except for “SCATTER”, are aligned on a winning line WL, a winning combination is established. Meanwhile, as for “SCATTER”, when three or more of “SCATTER” are rearranged, a winning combination is established.

FIG. 6B is a view showing the possibility for establishment of each winning combination and the number of payouts.

When five of the bonus game trigger “APPLE” are arranged on the winning line WL, a winning combination is established, and a predetermined number of times (e.g. 10 times) of free games are played. The free game is played, even without insertion of coins, as if the same number of coins as inserted at the time of establishment of the winning combination for the free game were inserted.

“JACKPOT7” is a jackpot trigger. If five of the “JACKPOT7” are arranged along a winning line WL, a payout is conducted based on a progressive jackpot. Since the slot machine 10 is a standalone type slot machine, the payout based on the progressive jackpot is the sum of an accumulated value (a value resulted from accumulation of a portion of the number of inserted game media) in the single slot machine 10 and an initial payout value.

However, in the present invention, the accumulated value used in the event of a progressive jackpot is not limited thereto. For example, in the case where the slot machine is connected to a network, the accumulated value may be an accumulated value in the same type of slot machines in a single casino, an accumulated value in the same type of slot machines in the same area (for example, state or country), or the like.

The payout number of coins per inserted coin is set with respect to “BLUE7”, “BELL”, “STRAWBERRY”, “PLUM”, “CHERRY” and “ORANGE”. Further, there exist winning combinations of “SCATTER×3”, “SCATTER×4” and “SCATTER×5” established by “SCATTER”, and a different payout number of coins is set with respect to each of those winning combinations.

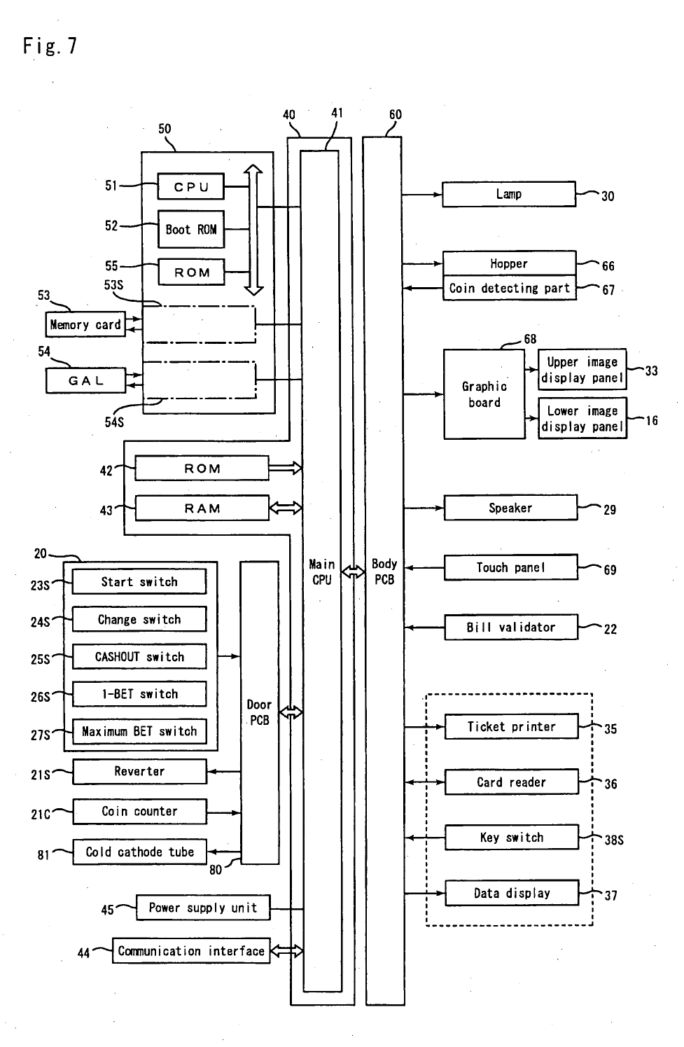

FIG. 7 is a block diagram showing the internal construction of the slot machine shown in FIG. 5.

A gaming board 50 includes: CPU (Central Processing Unit) 51, ROM 55 and boot ROM 52 which are interconnected to one another by an internal bus; a card slot 53S which accepts a memory card 53; an IC socket 54S which accepts GAL (Generic Array Logic) 54.

The memory card 53 is formed from a nonvolatile memory such as CompactFlash (registered trademark) and stores game programs and game system programs. The game programs include a symbol selection program. The aforementioned symbol selection program is a program for determining the symbols to be rearranged in a symbol matrix. The aforementioned symbol selection program includes symbol weighing data in association with a plurality of types of payout ratios (for example, 80%, 84%, 88%). The symbol weighing data is data indicating the correspondence between respective symbols and one or more random numbers which fall in a predetermined numerical range (0 to 255). The payout ratios are determined based on payout-ratio setting data output from the GAL 54 and, based on the symbol weighing data associated with the payout ratios, the symbols to be rearranged in the symbol matrix are determined. Further, the game programs include table data (see FIG. 6B) indicating the correspondence between symbols and payout rates.

Further, the card slot 53S is configured to allow the memory card 53 to be inserted thereinto or ejected therefrom and is connected to a mother board 40 through an IDE bus. Accordingly, the memory card 53 can be ejected from the card slot 53S, then other game programs and other game system programs can be written into the memory card 53 and then the memory card 53 can be inserted into the card slot 53S to change the types and contents of games played in the slot machine 10. The game programs include programs relating to progression of games. Further, the game programs include image data and sound data to be output during games. The image data includes image data and the like indicating a symbol matrix.

The GAL 54 is a type of PLD having a fixed OR array structure. The GAL 54 includes a plurality of input ports and a plurality of output ports and, if predetermined data is input to an input port, the GAL 54 outputs data corresponding to the aforementioned data from an output port. The data output from this output port is the aforementioned payout-ratio setting data.

Further, the IC socket 54S is configured to allow the GAL 54 to be attached thereto and detached therefrom and is connected to the mother board 40 through a PCI bus. Accordingly, the GAL 54 can be replaced with another GAL 54 to change the payout-ratio setting data.

CPU 51, ROM 55 and boot ROM 52 interconnected to each other by the internal bus are connected to the mother board 40 by PCI bus.

The mother board 40 is constructed with a general-purpose mother board commercially available (a printed circuit board on which basic parts of a personal computer are mounted) and includes: a main CPU 41; ROM (Read Only Memory) 42; RAM (Random Access Memory) 43 and a communication interface 44. The mother board 40 is the controller of the present invention.

ROM 42 is constituted of a memory device such as a flash memory and stores thereon a program such as BIOS (Basic Input/Output System) executed by the main CPU 41 and permanent data. When BIOS is executed by the main CPU 41, not only is an initialization processing for predetermined peripheral devices conducted, but a capture processing for the game program and game system program stored on the memory card 53 is also started via the gaming board 50. In the present invention, contents of ROM 42 may be rewritable or not rewritable.

RAM 43 stores data and a program used at the time of operation of the main CPU 41. RAM 43 can also store the game program. RAM 43 further stores data on the number of credits, the number of coin-in or coin-out for one game, and the like.

Both a body PCB (Printed Circuit Board) 60 and a door PCB 80 which will be described later are connected to the mother board 40 by USB. A power supply unit 45 is also connected to the mother board 40.

Equipment and devices which generate input signals to be input to the main CPU 41, and equipment and devices of which operations are controlled by a control signal output from the main CPU 41 are connected to the body PCB 60 and the door PCB 80. The main CPU 41 executes a game program stored in RAM 43 based on an input signal input to the main CPU 41, and thereby performs a predetermined computational processing, stores results thereof into RAM 43 and transmits a control signal to each equipment and device as a control processing for each of the equipment and devices.

A lamp 30, a hopper 66, a coin detecting section 67, a graphic board 68, a speaker 29, a touch panel 69, a bill validator 22, a ticket printer 35, a card reader 36, a key switch 38S and a data display 37 are connected to the body PCB 60. The lamp 30 is lit up in a predetermined pattern based on a control signal output from the main CPU 41.

The hopper 66 is installed in the cabinet 11 and pays out a predetermined number of coins from a coin payout exit 19 to a coin tray 18 based on a control signal output from the main CPU 41. A coin detecting section 67 is installed inside the coin payout exit 19 and when detecting that a predetermined number of coins has been paid out from the coin payout exit 19, outputs an input signal to the main CPU 41.

The graphic board 68 controls, based on a control signal output from the main CPU 41, image displays within the upper image display panel 33 and the lower image display panel 16. The number of credits stored in RAM 43 is displayed to the number-of-credits display section 31 (not shown in the figure) of the lower image display panel 16. The number of coin-out is displayed to the number-of-payouts display section 31 (not shown in the figure) of the lower image display panel 16. The graphic board 68 is equipped with VDP (Video Display Processor) which generates image data based on a control signal output from the main CPU 41 and a video RAM which temporarily stores image data generated by VDP, and of the like equipments. Note that image data used in generating image data with VDP is contained in a game program read from the memory card 53 and stored in RAM 43.

The bill validator 22 not only discriminates a true note from a false note, but also accepts the true note into the cabinet 11. The bill validator 22, when accepting a true note, outputs an input signal to the main CPU 41 based on a face amount of the note. The main CPU 41 stores in RAM 43 the number of credits corresponding to the amount of the note transmitted with the input signal.

The ticket printer 35, based on a control signal output from the main CPU 41, prints on a ticket a bar code obtained by encoding data such as the number of credits, date and time, the identification number of the slot machine 10, and of the like data stored in RAM 43, and outputs the ticket as the ticket 39 with a bar code.

The card reader 36 transmits to the main CPU 41 data read from the smart card and writes data onto the smart card based on a control signal from the main CPU 41. The key switch 38S is provided on the key pad 38, and when the key pad 38 is operated by a player, outputs a predetermined input signal to the main CPU 41. The data display 37 displays, based on a control signal output from the main CPU 41, data read by the card reader 36 and data input by a player through the key pad 38.

The control panel 20, a reverter 21S, a coin counter 21C and a cold cathode tube 81 are connected to the door PCB 80. The control panel 20 is provided with a start switch 23S corresponding to the start button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. When the buttons 23 to 27 are operated by a player, each of the switches 23S to 27S corresponding thereto outputs input signals to the main CPU 41.

The coin counter 21C is installed inside the coin receiving slot 21, and discriminates whether a coin inserted by a player into the coin receiving slot 21 is true or false. Coins other than the true ones are discharged from the coin payout exit 19. The coin counter 21C also outputs an input signal to the main CPU 41 when a true coin is detected.

The reverter 21S operates based on a control signal output from the main CPU 41 and distributes coins recognized by the coin counter 21C as true coins into a cash box (not shown in the figure) or the hopper 66, which are disposed in the slot machine 10. In other words, when the hopper 66 is filled with coins, true coins are distributed by the reverter 21S into the cash box. On the other hand, when the hopper 66 is not filled with coins, true coins are distributed into the hopper 66. The cold cathode tube 81 works as a backlight installed on the back face sides of the lower image display panel 16 and the upper image display panel 33 and is lit up based on a control signal output from the main CPU 41.

Next, description will be given of a processing performed in the slot machine 10.

The main CPU 41 reads and executes the game program to progress a game.

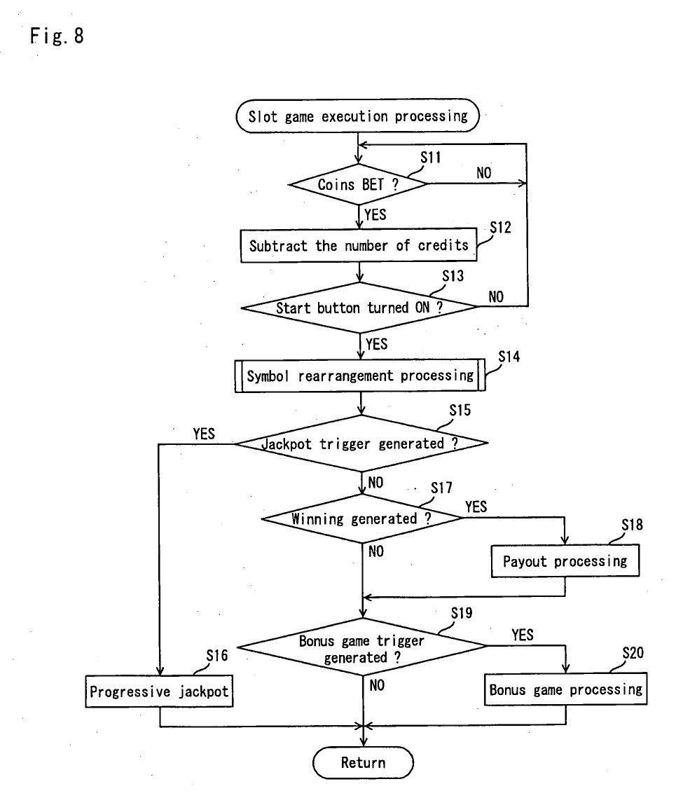

FIG. 8 is a flowchart showing a subroutine of a slot game execution processing.

In the slot game execution processing, the main CPU 41 at first determines whether or not a coin is BET (step S11). In the processing, the main CPU 41 determines whether an input signal output from the 1-BET switch 26S or the maximum BET switch 27S has been received or not when the 1-BET button 26 or the maximum BET button 27 is operated, respectively. If it is determined that a coin has not been BET, the process returns to step S11.

On the other hand, if it is determined in step S11 that a coin is BET, the main CPU 41 conducts a processing for subtracting the number of credits stored in RAM 43 according to the number of BET coins (step S12). In a case where the number of BET coins is more than the number of credits stored in RAM 43, the process returns to step S11 without conducting subtraction on the number of credits stored in RAM 43. In a case where the number of BET coins exceeds the upper limit (3 coins in the present embodiment) up to which a BET is possible in one game, the process advances to step S12 without conducting a processing for subtracting the number of BET coins from the number of credits stored in RAM 43. Further, the main CPU 41 cumulatively accumulates, in the RAM 43, a portion of the subtracted number of credits (for example, a predetermined ratio) as an accumulated value for a progressive jackpot.

Then, the main CPU 41 determines whether the start button 23 has been turned ON or not (step S13). In the processing, the main CPU 41 determines, when the start button 23 is pressed, whether an input signal output from the start switch 23S has been received or not.

If it is determined that the start button 23 has not been turned ON, the process returns to step S11. Note that in a case where the start button 23 has not been turned ON (for example, in a case where a command of terminating a game has been input without turning ON the start button 23), the main CPU 41 cancels a result of the subtracting processing in step S12.

On the other hand, if the main CPU 41 determines at the step S13 that the start button 23 has been turned ON, then the main CPU 41 conducts a symbol rearrangement processing (step S14).

Hereinafter, the symbol rearrangement processing will be described.

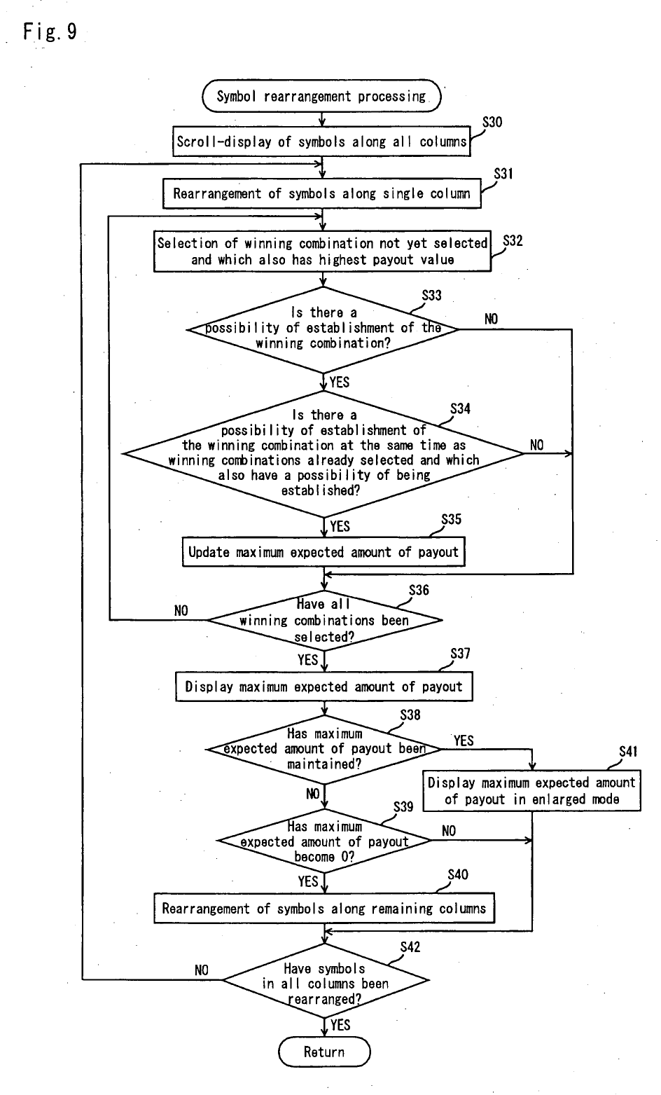

FIG. 9 is a flow chart illustrating the subroutine of the symbol rearrangement processing. At the time of start of the processing of FIG. 9, a plurality of types of winning combinations have been displayed to the upper image display panel 33, as illustrated in FIG. 1.

First, as shown in FIG. 1, the main CPU 41 starts scroll-displays of all the symbols included in the symbol matrix SM within the lower image display panel 16 (step S30). At this time, the winning lines WL1 to WL5 set in the symbol matrix SM are made effective according to the number of BETs.

Next, the main CPU 41 rearranges the symbols S belonging to one of the columns C of the symbol matrix SM (step S31). In this process, the main CPU 41 executes the foregoing symbol selection program, to determine the symbols S belonging to the column C. It is to be noted that the columns on which the symbols are rearranged may be selected at random, or may be selected in a predetermined order.

Next, the main CPU 41 repeatedly conducts processes at steps S32 to S36 to calculate a maximum expected amount of payout. In this case, the processes at the steps S32 to S36 are repeatedly conducted. At the step S32, the main CPU 41 selects a winning combination not yet selected and which also has a highest payout value and, at the steps S33 to S35, the main CPU 41 determines whether or not the payout value of the winning combination should be added to the maximum expected amount of payout, and conducts processing for adding the payout value to the maximum expected amount of payout.

At first, at the step S32, the main CPU 41 selects a winning combination not yet selected and which also has a highest payout value. In this case, the term “a winning combination not yet selected” means a winning combination which has not yet been selected at the step S32, during repeated execution of the processes at the steps S32 to S36.

Then, the main CPU 41 determines whether or not the winning combination selected at the step S32 has a possibility of being established, based on the rearranged symbols(step S33). If the main CPU 41 determines that the winning combination selected at the step S32 has a possibility of being established, then the main CPU 41 determines whether or not the winning combination selected at the step S32 has a possibility of being established at the same time as the winning combinations already selected and which also have a possibility of being established (step S34). In this case, the term “winning combinations already selected” means winning combinations which have been already selected at the step S32 during repeated execution of the processes at the steps S32 to S36.

If the winning combination selected at the step S32 has a possibility of being established (step S33: YES) and also has a possibility of being established at the same time as the winning combinations already selected and which also have a possibility of being established (step S34: YES), the payout value of the winning combination is added to the maximum expected amount of payout and the resultant maximum expected amount of payout is stored in the RAM 43 (step S35). Then, the main CPU 41 determines whether or not all the winning combinations have been selected and, if all the winning combinations have not yet been selected, the process is returned to the step S32. On the other hand, if the main CPU 41 determines that all the winning combinations have been selected, then the main CPU 41 finally displays the maximum expected amount of payout updated at the step S35, to the upper image display panel 33 (step S37).

Thereafter, the main CPU 41 determines whether or not the maximum expected amount of payout has been maintained, namely whether or not the current calculated maximum expected amount of payout is equal to the previous calculated maximum expected amount of payout (step S38). If the main CPU 41 determines that the maximum expected amount of payout has not been maintained, then the main CPU 41 determines whether or not the maximum expected amount of payout has become 0 (step S39). If the main CPU 41 determines that the maximum expected amount of payout has become 0, then symbols are rearranged along the remaining columns (step S40). Thus, if the maximum expected amount of payout has become 0, then the current round of game can be finished.

On the other hand, if the main CPU 41 determines, at the step S38, that the maximum expected amount of payout has been maintained, then the main CPU 41 displays the maximum expected amount of payout in an enlarged mode (step S41). If the processing at the step S40 or S41 has been conducted, the main CPU 41 determines whether or not symbols S have been rearranged along all the columns C (step S42). When it is determined that the symbols S on all the columns C have not been rearranged, the process is returned to step S31. Meanwhile, when it is determined that the symbols S on all the columns have been rearranged, the present subroutine is completed, and the process is returned to the subroutine shown in FIG. 8.

After the main CPU 41 finishes the symbol rearrangement processing, the main CPU 41 determines whether or not a jackpot trigger has been generated, namely whether or not a winning combination “JACKPOT7” has been generated along a winning line (step S15). If it is determined that a jackpot trigger has been generated, a progressive jackpot is executed (step S16). The number of coins to be paid out based on a progressive jackpot corresponds to the accumulated value (a value resulted from accumulation of a portion of the number of inserted game media) stored in the RAM 43 plus an initial payout value, and the payout thereof is performed through hand-pay. At the step S16, the main CPU 41 conducts processing such as, for example, outputting of notification sound from a speaker 29, lighting of a lamp 30, printing of the ticket 39 with a bar code having a bar code indicating the number of coins to be paid out printed thereon. Thereafter, the present subroutine is terminated.

On the other hand, if the main CPU 41 determines, at the step S15, that no jackpot trigger has been generated, the main CPU 41 determines whether or not a prize has been generated (step S17). In this case, the generation of a prize means generation of at least one winning combination out of “BLUE7”, “BELL”, “STRAWBERRY”, “PLUM”, “CHERRY”, “ORANGE”, “SCATTER×3”, “SCATTER×4” and “SCATTER×5” along a winning line (see FIG. 6B).

If the main CPU 41 determines that a prize has been generated, the main CPU 41 pays out coins, according to the number of coins to be paid out defined for the winning combination and the number of BETs (step S18). If the coins are to be accumulated, the main CPU 41 conducts processing for adding a predetermined number of credits to the number of credits stored in the RAM 43. On the other hand, if the coins are to be paid out, the main CPU 41 transmits a control signal to the hopper 66 to cause it to pay out a predetermined number of coins.

If it is determined, at the step S17, that no prize has been generated or if the processing at the step S18 has been conducted, the main CPU 41 determines whether or not a bonus game trigger has been generated, namely whether or not “APPLE” has been generated along a winning line (step S19). If the main CPU 41 determines that a bonus game trigger has been generated, the main CPU 41 reads, from the RAM 43, a program for executing a predetermined number of free games as a bonus game and executes a bonus game processing (step S20). If the main CPU 41 determines, at the step S19, that no bonus game trigger has been generated or if the processing at the step S20 has been conducted, the present subroutine is terminated.

As described above, the slot machine 10 according to the present embodiment includes the lower image display panel 16 and the upper image display panel 33, as displays. A total of 15 symbols S along 5 columns and 3 rows are to be arranged to the lower image display panel 16. The upper image display panel 33 is capable of displaying a payout value based on symbols S. Further, the slot machine 10 includes the main CPU 41 which rearranges a plurality of symbols S sequentially over a plurality of times within the lower image display panel 16. During the rearrangement processing, the main CPU 41 calculates a maximum expected amount of payout based on the rearranged symbols and displays the maximum expected amount of payout to the upper image display panel 33.

Further, the slot machine 10 conducts a slot machine playing method according to the present invention, as follows.

The main CPU 41 rearranges a plurality of symbols sequentially over a plurality of times to the lower image display panel 16 (display). During the rearrangement processing, the main CPU 41 calculates a maximum expected amount of payout based on the rearranged symbols and displays the maximum expected amount of payout to the upper image display panel 33 (display).

While there was described the case where the symbols are displayed to the display in the foregoing embodiment, the present invention is not limited to this example, and for example, mechanical reels may be adopted as described below.

FIG. 10 is a perspective view schematically showing a slot machine according to another embodiment of the present invention. A slot machine 100 comprises the lower image display panel 16. The lower image display panel 16 has a transparent crystal liquid panel switchable to either a transparent state or a non-transparent state. Five reels 14 are arranged side-by-side on the back side of the lower image display panel 16, and a display window 15 is formed which displays three symbols drawn on the peripheral face of each of the reels 14 at the position corresponding to each of the reels 14 on the lower image display panel 16. The five reels 14 and the display window 15 which displays three symbols per reel 14 form the symbol matrix SM consisting of a total 15 of (5×3) symbols.

FIG. 11 is a perspective view schematically showing a slot machine according to another embodiment of the present invention. A slot machine 110 comprises the lower image display panel 16. The lower image display panel 16 has a transparent crystal liquid panel switchable to either a transparent state or a non-transparent state. On the back side of the lower image display panel 16, 15 (5×3) reels 140 are arranged, and a display window 150 is formed which displays one symbol drawn on the peripheral face of each of the reels 140 at the position corresponding to each of the reels 140. The 15 reels 140 and the display window 150 which displays one symbols per reel 140 form the symbol matrix SM consisting of a total of 15 (5×3) symbols.

Although the embodiment according to the present invention is described, the description presents only some of the specific examples, and is not intended to limit the present invention in any way and specific constructions of each means and the like can be properly changed in terms of design. Besides, the effects described in the embodiment of the present invention are only the most preferable effects generated from the present invention and effects to be caused by the present invention is not limited to those described in the embodiment of the present invention.

There has thus been outlined, rather broadly, the more important features of the invention in order that the detailed description thereof aforementioned may be better understood, and in order that the present contribution to the art may be better appreciated. There are, of course, additional features of the invention that described above and which formed the subject matter of the claims appended hereto.

In this respect, above explaining at least one embodiment of the invention in detail, it is to be understood that the invention is not limited in its application to the details of construction and to the arrangements of the components set forth in the aforementioned description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

The detailed descriptions aforementioned may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine and/or manual operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

What is claimed as new and desired to be secured by Letters Patent of the United States is:

1. A slot machine comprising:
a display to which a plurality of symbols are to be arranged and which is also capable of displaying an amount of payout based on said symbols; and
a controller,
said controller rearranging a plurality of symbols sequentially over a plurality of times within said display,
calculating a maximum amount of payout which can be paid out in rearrangement of symbols not yet rearranged, based on the rearranged symbols, said maximum amount of payout calculated during one of said sequential rearrangement processes, and
displaying the calculated maximum amount of payout to said display.

2. The slot machine according to claim 1,
wherein
said controller further comprises
changing an effect within said display when the maximum amount of payout which can be paid out in rearrangement of symbols not yet rearranged is maintained as a result of the rearrangement of symbols in said rearrangement process.

3. The slot machine according to claim 1,
wherein
said controller further comprises
finishing the current round of game when the amount of payout which can be paid out in rearrangement of symbols not yet rearranged becomes 0 as a result of the rearrangement of symbols in said rearrangement process.

4. A slot machine comprising:
a display to which a plurality of symbols are to be arranged and which is also capable of displaying an amount of payout based on said symbols; and
a controller,
said controller rearranging a plurality of symbols sequentially over a plurality of times within said display,
calculating a maximum amount of payout which can be paid out in rearrangement of symbols not yet rearranged, based on the rearranged symbols, said maximum amount of payout calculated during one of said sequential rearrangement processes,
displaying the calculated maximum amount of payout to said display, and
changing an effect within said display when the maximum amount of payout which can be paid out in rearrangement of symbols not yet rearranged is maintained as a result of the rearrangement of symbols in said rearrangement process.

5. The slot machine according to claim 4,
wherein
said controller further comprises
finishing the current round of game when the amount of payout which can be paid out in rearrangement of symbols not yet rearranged becomes 0 as a result of the rearrangement of symbols in said rearrangement process.

6. A slot machine comprising:
a display to which a plurality of symbols are to be arranged and which is also capable of displaying an amount of payout based on said symbols; and
a controller,
said controller rearranging a plurality of symbols sequentially over a plurality of times within said display,
calculating a maximum amount of payout which can be paid out in rearrangement of symbols not yet rearranged, based on the rearranged symbols, said maximum amount of payout calculated during one of said sequential rearrangement processes,
displaying the calculated maximum amount of payout to said display,
changing an effect within said display when the maximum amount of payout which can be paid out in rearrangement of symbols not yet rearranged is maintained as a result of the rearrangement of symbols in said rearrangement process, and
finishing the current round of game when the amount of payout which can be paid out in rearrangement of symbols not yet rearranged becomes 0 as a result of the rearrangement of symbols in said rearrangement process.

7. A playing method of a slot machine comprising the steps of:
rearranging a plurality of symbols sequentially over a plurality of times within a display to which a plurality of symbols are to be arranged and which is also capable of displaying an amount of payout based on said symbols;
calculating the maximum amount of payout which can be paid out in rearrangement of symbols not yet rearranged, based on the rearranged symbols, said maximum amount of payout calculated during one of said sequential rearrangement processes; and
displaying the calculated maximum amount of payout to said display, each of said steps conducted by a controller.

8. The playing method of a slot machine according to claim 7,
wherein
said controller further comprises
changing an effect within said display when the maximum amount of payout which can be paid out in rearrangement of symbols not yet rearranged is maintained as a result of the rearrangement of symbols in said rearrangement process.

9. The playing method of a slot machine according to claim 7,
wherein
said controller further comprises
finishing the current round of game when the amount of payout which can be paid out in rearrangement of symbols not yet rearranged becomes 0 as a result of the rearrangement of symbols in said rearrangement process.

10. A playing method of a slot machine comprising:
rearranging a plurality of symbols sequentially over a plurality of times within a display to which a plurality of symbols are to be arranged and which is also capable of displaying an amount of payout based on said symbols;
calculating the maximum amount of payout which can be paid out in rearrangement of symbols not yet rearranged, based on the rearranged symbols, said maximum amount of payout calculated during one of said sequential rearrangement processes;
displaying the calculated maximum amount of payout to said display; and
changing an effect within said display when the maximum amount of payout which can be paid out in rearrangement of symbols not yet rearranged is maintained as a result of the rearrangement of symbols in said rearrangement process, each of said steps conducted by a controller.

11. The playing method of a slot machine according to claim 10,
wherein
said controller further comprises
finishing the current round of game when the amount of payout which can be paid out in rearrangement of symbols not yet rearranged becomes 0 as a result of the rearrangement of symbols in said rearrangement process.

12. A playing method of a slot machine comprising:
rearranging a plurality of symbols sequentially over a plurality of times within a display to which a plurality of symbols are to be arranged and which is also capable of displaying an amount of payout based on said symbols;
calculating the maximum amount of payout which can be paid out in rearrangement of symbols not yet rearranged, based on the rearranged symbols, said maximum amount of payout calculated during one of said sequential rearrangement processes;
displaying the calculated maximum amount of payout to said display;
changing an effect within said display when the maximum amount of payout which can be paid out in rearrangement of symbols not yet rearranged is maintained as a result of the rearrangement of symbols in said rearrangement process; and
finishing the current round of game when the amount of payout which can be paid out in rearrangement of symbols not yet rearranged becomes 0 as a result of the rearrangement of symbols in said rearrangement process, each of said steps conducted by a controller.
